(19) United States
(12) Patent Application Publication
(10) Pub. No.: US 2026/0201986 A1
(43) Pub. Date: Jul. 16, 2026

(54) PLUG CONNECTOR

(71) Applicant: Carl Freudenberg KG, Weinheim (DE)

(72) Inventors: Walter ZIFLE, Königswinter (DE); Ralf HELDMANN, Wald-Michelbach (DE); Rouven RATFISCH, Gernsheim (DE); Günter ZIEGLER, Mannheim (DE); Markus CLEMENS, Reichelsheim (DE)

(21) Appl. No.: 19/135,460

(22) PCT Filed: Nov. 30, 2023
(86) PCT No.: PCT/EP2023/083688

§ 371 Date: Jun. 4, 2025

(30) Foreign Application Priority Data
Dec. 9, 2022 (DE) 10 2022 132 760.4

(51) Int. Cl. F16L 21/03; B32B 1/00; B32B 25/04

(52) U.S. Cl. CPC F16L 21/03; B32B 1/00; B32B 25/042; B32B 2250/02; B32B 2250/248; B32B 2597/00

(57) ABSTRACT

A plug-in connector including a first support part that has a first end face and a second end face, and a second support part. The first support part and the second support part are each formed in a substantially tubular manner. The second support part encloses the first end face of the first support part at its external circumference at a radial distance. A spring member made of a flexible rubber material is arranged in the gap formed by the radial distance and connects the first support part and the second support part in a resiliently flexible manner in a radial direction.

### CROSS REFERENCE TO RELATED APPLICATIONS

This application is a U.S. National Phase application under 35 U.S.C. § 371 of International Application No. PCT/EP2023/083688, filed on Nov. 30, 2023, and claims benefit to German Patent Application No. DE 10 2022 132 760.4, filed on Dec. 9, 2022. The International Application was published in German on Jun. 13, 2024 as WO 2024/120949 A1 under PCT Article 21(2).

### FIELD

The invention relates to a plug-in connector.

### BACKGROUND

Plug-in connectors are generally known and are used for sealing media-carrying circuits, for example for sealing cooling-water or oil circuits. In this context, plug-in connectors ensure that pipes or ducts are tightly coupled to housings or between machine elements.

EP 1 024 322 B1 discloses a plug-in connector. This known plug-in connector is used for tightly connecting two tubular hollow bodies arranged next to one another at an axial distance from one another and comprises a support part that is formed as a connection sleeve and made of hard and tough material, the support part being enclosed at its end faces on both sides by sealing beads made of elastomeric material. The sealing beads protrude in the axial direction beyond the support part at its end faces on both sides.

Each overhang is formed as a sealing lip, which tapers in cross section in the axial direction, forms a circumferential gap in the radial direction in relation to the inner wall of each hollow body when overpressure is not applied inside the plug-in connector, and, when overpressure is applied inside the plug-in connector, is positioned tightly against the hollow body inner wall that encloses the end face at its external circumference. Owing to the sealing lips, which can be made to resiliently spring back in the radial direction, overpressures inside the plug-in connector are sealed up to 60 bar, without any of the medium that is being sealed leaking in the sealing region.

### SUMMARY

In an embodiment, the present disclosure provides a plug-in connector including a first support part that has a first end face and a second end face, and a second support part. The first support part and the second support part are each formed in a substantially tubular manner. The second support part encloses the first end face of the first support part at its external circumference at a radial distance. A spring member made of a flexible rubber material is arranged in the gap formed by the radial distance and connects the first support part and the second support part in a resiliently flexible manner in a radial direction

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a longitudinal section along the line B-B from FIG. 2 through an embodiment of a plug-in connector according to the present disclosure;

FIG. 2 is a front view of the plug-in connector from FIG. 1;

FIG. 3 is a perspective view of the plug-in connector from FIG. 1 and FIG. 2; and

FIG. 4 shows the plug-in connector from FIG. 1 in a sealing arrangement that comprises the plug-in connector.

### DETAILED DESCRIPTION

An embodiment of the present disclosure includes a plug-in connector that can compensate for axial misalignment of machine elements that are to be joined together.

Problems associated with conventional plug-in connectors are solved by the plug-in connector of the present disclosure.

An embodiment of the present disclosure includes a plug-in connector that comprises a first support part, having a first end face and a second end face, and a second support part, the support parts each being formed in a substantially tubular manner, the second support part enclosing the first end face of the first support part at its external circumference at a radial distance therefrom, and a spring member made of a flexible rubber material being arranged in the gap formed by said distance and connecting the first support part and the second support part in a resiliently flexible manner in the radial direction.

The spring member between the first and the second support part makes it possible to compensate for axial misalignment of machine elements joined together by the plug-in connector.

Radial and axial tolerances of the machine elements-whether production-or assembly-related-can also be compensated for by the spring member of the plug-in connector of the present disclosure.

In embodiments of the present disclosure, to provide sealing between the machine elements joined together by the plug-in connector, it is provided that the second end face is enclosed at its external circumference by a first sealing bead. In an embodiment of the present disclosure, the first sealing bead can be formed in a convex manner when viewed in the longitudinal section of the plug-in connector. The advantage here is that the convex shape of the sealing bead makes assembling the plug-in connector simpler, as the convex shape results in assembly bevels by which the plug-in piece can be assembled in a simple manner without the first sealing bead being damaged. Moreover, undesirably high mechanical stresses in the first sealing bead are prevented since material of the first sealing bead displaced as a result of assembly can divert into the axially adjacent regions, which are subject to less mechanical load.

In an embodiment of the present disclosure, the first sealing bead preferably consists of a flexible rubber material. Flexible rubber sealing materials are available at low cost in many specifications.

In an embodiment of the present disclosure, the first sealing bead can have an annular first axial seal on its side facing away from the first end face in the axial direction. The first axial seal can ensure axial sealing with respect to a cooling-water connection flange, for example.

In an embodiment of the present disclosure, the first sealing bead and the first axial seal are preferably formed so as to merge integrally into one another. As a result, the plug-in connector is simple and cost-effective to produce.

In an embodiment of the present disclosure, on the side facing radially away from the spring member, the second support part can have a second sealing bead that encloses the second support part at its external circumference. The second sealing bead seals a machine element.

In an embodiment of the present disclosure, the second sealing bead preferably also consists of a flexible rubber material having the same advantages as described above.

In an embodiment of the present disclosure, the second support part can have an annular second axial seal on its side facing away from the second end face in the axial direction, said second axial seal being able to be positioned tightly against an end face of a machine element with axial preloading.

In an embodiment of the present disclosure, the second sealing bead and the second axial seal are preferably likewise formed so as to merge integrally into one another.

An advantage in terms of producing the plug-in connector in a simple and cost-effective manner, as well as advantages in terms of material-specific recycling once the plug-in connector has finished being used, can be obtained by forming the second sealing bead, the second axial seal, and the spring member so as to merge integrally into one another and by making them out of one and the same material, as is the case with the spring member and the first sealing bead.

In an embodiment of the present disclosure, the second support member can be formed by an L-shaped bracket piece having a radial leg and an axial leg. The bracket piece can be formed, for example, by an angle plate. The advantage of a support member of this kind is that it is easy to guide in a machine element to be sealed using the axial leg, and also the radial leg is formed as an axial stop for a machine element to be sealed. This simplifies the assembly of the plug-in connector and machine element. The plug-in connector and machine element are always positioned correctly with respect to one another owing to the L-shaped bracket piece.

In an embodiment of the present disclosure and to provide advantageous sealing of the axial leg in the machine element, it can be provided that the axial leg is enclosed at its external circumference by the second sealing bead.

In an embodiment of the present disclosure, the second sealing bead can have at least two sealing lips arranged next to one another in the axial direction and formed to be closed in the circumferential direction. Owing to the second sealing bead and the sealing lips, the plug-in connector provides consistently good sealing with respect to a machine element that is to be sealed, over a long service life.

In an embodiment of the present disclosure, the first support part can be connected to the first sealing bead, and/or the second support part connected to the second sealing bead, in an interlocking and/or integrally bonded manner.

The manner in which the support part and the corresponding sealing bead are coupled is selected by a person skilled in the art entrusted with building plug-in connectors, depending on the circumstances in each particular use case.

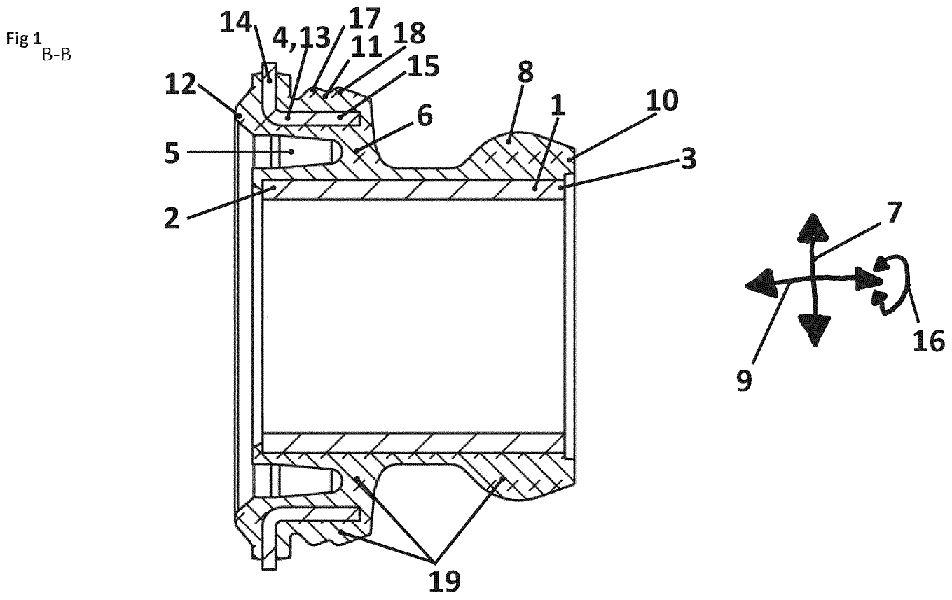

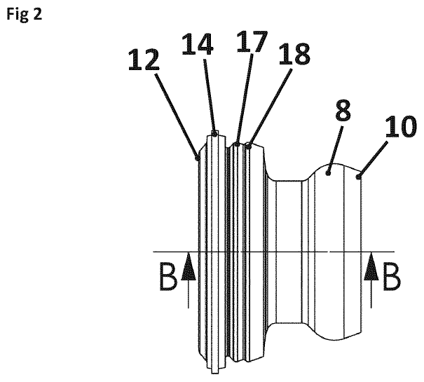

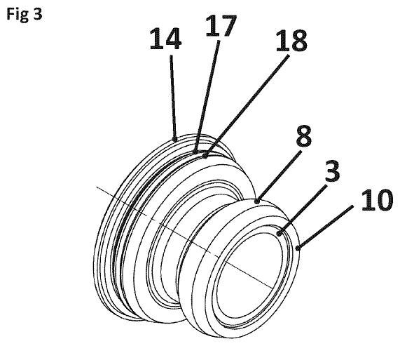

FIGS. 1 to 3 show an embodiment of the plug-in connector according to the present disclosure.

The plug-in connector comprises a first support part 1 and a second support part 4, which are each formed in a tubular manner. The second support part 4 encloses the first support part 1 at its external circumference in the region of its first end face 2 at a radial distance therefrom, said distance forming the gap 5. The first support part 1 and the second support part 4 each consist of a hard and tough material, for example of a metal material or a polymer material. The spring member 6 is arranged inside the gap 5 in order to allow a relative radial misalignment between the two support parts 1, 4 to be compensated for.

In addition to the two support parts 1, 4, the plug-in connector comprises a unit 19 that comprises the spring member 6, the first sealing bead 8, and the second sealing bead 11. The unit 19 is formed so as to merge together integrally, is made of one and the same material, and consists of a flexible rubber material. In this exemplary embodiment, the unit 19 is connected to the support parts 1, 4 by an integral bond.

The second support part 4 encloses the first support part 1 in the region of the first end face 2 of the first support part 1.

The second end face 3 of the first support part 1, on the other hand, is enclosed at its external circumference by the first sealing bead 8.

The second support part 4, which is formed as an L-shaped bracket piece 13, comprises the radial leg 14 and the axial leg 15, which is enclosed at its external circumference, on its side facing radially away from the spring member 6, by the second sealing bead 11.

Both the first sealing bead 8 and the second sealing bead 11 each have annular axial seals 10, 12, which can be positioned, in a resiliently flexible and tight manner, against a corresponding surface of a machine element, as needed and with axial preloading, during proper use of the plug-in connector.

By contrast with the first sealing bead, which is formed in a convex manner when viewed in the longitudinal section of the plug-in connector, the second sealing bead 11 comprises two sealing lips 17, 18, which are arranged next to one another in the axial direction 9 and are formed to be closed in the circumferential direction 16.

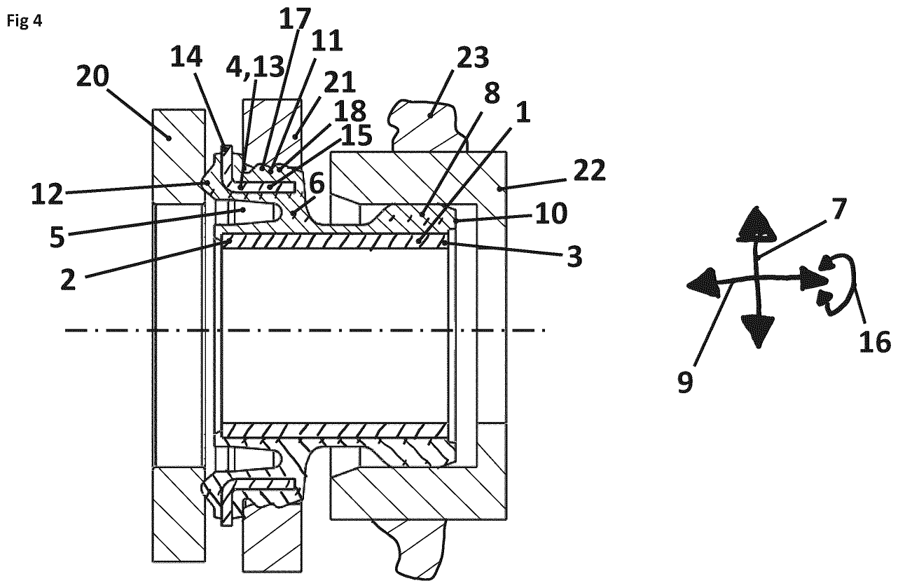

FIG. 4 shows a sealing arrangement that comprises the plug-in connector from FIGS. 1 to 3.

In the exemplary embodiment shown in FIG. 4, three independent machine elements 20, 21, 22 are sealed with respect to one another by the plug-in connector. The machine elements 20, 21, 22 may have a radial misalignment and/or an angular misalignment relative to one another, but all types of misalignment of the machine elements 20, 21, 22 relative to one another are compensated for by the plug-in connector, in particular by the functional interaction between the first sealing bead 8 and the spring member 6. Owing to the first sealing bead 8 and the spring member 6 and their functional interaction, even a comparably large misalignment can be compensated for. The spring action and the resilient flexibility of the first sealing bead 8 and the spring member 6 are both comparably high and combine as needed in order to compensate for misalignment during proper use of the plug-in connector.

The machine elements 20, 22 are part of a cooling circuit in the field of e-mobility.

The machine element 21 is a housing wall and is part of a housing 23, for example an inverter housing of an e-drive.

The machine element 20 is a connection piece that is sealed by the second axial seal 12.

The machine element 21 is sealed by the second sealing bead 11 by the two sealing lips 17, 18 thereof.

The machine element 22 is a connecting piece that is sealed by the first sealing bead 8.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A plug-in connector comprising:
a first support part having a first end face and a second end face; and
a second support part,
wherein the first support parts and the second support part are each formed in a substantially tubular manner,
wherein the second support part encloses the first end face of the first support part at its external circumference at a radial distance therefrom, and
wherein a spring member made of a flexible rubber material is arranged in the gap formed by the radial distance and connects the first support part and the second support part in a resiliently flexible manner in a radial direction.

2. The plug-in connector according to claim 1, wherein the second end face is enclosed at its external circumference by a first sealing bead.

3. The plug-in connector according to claim 2, wherein the first sealing bead is formed in a convex manner when viewed in a longitudinal section of the plug-in connector.

4. The plug-in connector according to claim 2, wherein the first sealing bead consists of a flexible rubber material.

5. The plug-in connector according to claim 2, wherein the first sealing bead has an annular first axial seal on its side facing away from the first end face in an axial direction.

6. The plug-in connector according to claim 5, wherein the first sealing bead and the annular first axial seal are formed so as to merge integrally into one another.

7. The plug-in connector according to claim 1, wherein, on a side facing radially away from the spring member, the second support part has a second sealing bead that encloses the second support part at its external circumference.

8. The plug-in connector according to claim 7, wherein the second sealing bead consists of a flexible rubber material.

9. The plug-in connector according to claim 7, wherein, on its side facing away from the second end face in the axial direction, the second support part has an annular second axial seal.

10. The plug-in connector according to claim 9, wherein the second sealing bead and the annular second axial seal are formed so as to merge integrally into one another.

11. The plug-in connector according to claim 9, wherein the second sealing bead, the annular second axial seal, and the spring member are formed so as to merge integrally into one another and are made of one and the same material.

12. The plug-in connector according to claim 2, wherein the spring member and the first sealing bead are formed so as to merge integrally into one another and are made of one and the same material.

13. The plug-in connector according to claim 1, wherein the second support part is formed by an L-shaped bracket piece having a radial leg and an axial leg.

14. The plug-in connector according to claim 13, wherein the radial leg is formed as an axial stop for a first machine element that is to be sealed.

15. The plug-in connector according to claim 13, wherein the axial leg is enclosed at its external circumference by a second sealing bead

16. The plug-in connector according to claim 15, wherein the second sealing bead has at least two sealing lips arranged next to one another in an axial direction and formed to be closed in a circumferential direction.

17. The plug-in connector according to claim 2, wherein the first support part is connected to the first sealing bead in an interlocking and/or integrally bonded manner.

18. The plug-in connector according to claim 7, wherein the second support part is connected to the second sealing bead in an interlocking and/or integrally bonded manner.
